(19) United States
(12) Patent Application Publication
(10) Pub. No.: US 2012/0322043 A1
(43) Pub. Date: Dec. 20, 2012

(54) ADAPTIVELY-SPACED REPETITION LEARNING SYSTEM AND METHOD

(75) Inventors: Darren Keith Edge, Beijing (CN); Stephen Alexander Fitchett, Christchurch (NZ); Matthew Robert Scott, Beijing (CN); Xianjun Huang, Beijing (CN)

(73) Assignee: Microsoft Corporation, Redmond, WA (US)

(21) Appl. No.: 13/163,297

(22) Filed: Jun. 17, 2011

(51) Int. Cl. G09B 7/00

(52) U.S. Cl. 434/322

(57) ABSTRACT

An adaptively-spaced repetition learning system and method facilitate the learning of material over time through the presentation of the material at ever-increasing intervals. Embodiments of the system and method present a stimulus-response pair to a student to obtain a binary response that is either correct or incorrect. The token is next presented to the student based on the student's response. If the response is correct, then the token is presented to the student based on the initial repetition interval without modification. If the response is incorrect, then the learnedness value is reset and the progression through the repetition intervals is restarted. In some embodiments, the initial repetition intervals are dynamically adjusted based on the student's response to obtain revised repetition intervals. This is achieved by manipulating the exponent of the mathematical term representing the curve of the repetition intervals.

### BACKGROUND

It is desirable to make maximum use of your time when you are learning. In order to maximize this efficiency several factors should be taken into account. These factors include motivating someone to begin and stay with the learning process, optimizing the time spent learning so that a person is not tested too frequently or infrequently, and deciding when to review old material and introduce new material.

Another way to improve efficiency is to make use of variable opportunities during a person's day to study. In other words, deciding whether it is more efficient to have a person learn productively in one minute ten times per day, ten minutes once a day, an hour a day, or an hour a week. This allows support of as many different kinds of learning as possible.

One type of dominant paradigm as to learning techniques is flash cards. In general, with flash cards the student is presented with a stimulus, mentally prepares a response, and then compares his response to the correct answer using the flash card.

The Leitner system is a technique for managing different piles of flashcards based on patterns of correct and incorrect responses. Flashcards are moved between piles that represent different degrees of learnedness, in response to correct and incorrect recall attempts. Successive piles are tested at greater intervals in time. The basic premise is to optimize learning efficiency by testing things that already known at ever-increasingly time intervals. The Leitner system is based on an underlying physical phenomenon known as the “forgetting curve.”

The “forgetting curve” represents the decline of memory retention over time. The “forgetting curve” says that you forget things at an exponential rate that depends on the initial strength of the association. Each time a person sees something again it strengthens the association of that thing, and it is forgotten more slowly. This means that if you want to learn something efficiently you see it frequently earlier on, and then over time you can afford to wait longer to check it again. This is because the strength of memory will have increased.

Another factor that influences learning is salience exposure. For example, a strong emotional involvement associated with an event will cause the memory of that event to be remembered longer. Most flashcard systems do not really account for the initial salience exposure to a particular thing that is being learned. These flashcard systems are heavily biased toward the frequency of repetition aspect of learning.

Another problem with flashcard systems is that there is no adaptivity that takes into account the fact that different people learn at different rates. Moreover, flashcard systems are bounded systems, which means that they assume that the student can review all the learning material in a certain period of time, such as each day. These flashcard systems do not take into account the learning problem whereby there may be an entire language to learn, and it is simply not possible to review the entire material each day.

One dominant paradigm for audio learning is called the Pimsleur approach. The Pimsleur approach uses 30-minute audio lessons that are not interactive, and the learner is instructed to advance to the next lesson when they feel they have mastered 80% of the content of the current lesson. The Pimsleur approach uses graduated repetition interval recall, whereby learned materials are reviewed at increasingly longer repetition intervals. The goal of this spaced recall is to help the student move vocabulary into long-term memory. One example of these so-called Pimsleur intervals is 5 seconds, 25 seconds, 2 minutes, 10 minutes, 1 hour, 5 hours, 1 day, 5 days, 25 days, 4 months, 2 years, and so forth.

One problem with the Pimsleur approach is that it does not work well for learning sessions less than half an hour in duration. It also does not work well in situations when the student finds some material much harder to master than other material in the same lesson. Moreover, the Pimsleur approach works well for audio learning, but has not been applied to visual learning.

None of the above-mentioned systems and approaches take into account the fact that if a student does not use the system for a while then he will forget some of that which he has learned. For example, assume a student uses a system to learn 1,000 Chinese characters, and then the student stops using the system for a while. When the student comes back to the system, the system will assume that the student still knows 1,000 Chinese characters, which will not be true. These systems do not take into account the fact that the student will have forgotten much of the learned material over time.

Some systems do rely on a notion that an item for learning may be overdue. But they do not take into account how likely it is that the student will have remembered the learned material in terms of probabilities that can be manipulated. They just know that it is overdue, and do not take into account what the chances are that the student remembers the learned material. Once the student forgets the learned material, there is no way for him to get back into using the system, because it has not taken into account the fact that he has not used the system for a while and has forgotten some of the material. This is a major challenge for nearly all learning systems currently on the market.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the adaptively-spaced repetition learning system and method facilitate the learning of material over time through the presentation of the material at repetition intervals. Embodiments of the system and method address the problem of learning and retaining facts that can be represented as a stimulus and a response. Embodiments of the system and method automatically schedule the introduction of new facts and the testing of old ones based on patterns of correct and incorrect responses over time. Embodiments of the system and method are designed to support learning in variable-length fragments of free time in a way that does not require completion of fixed-content “lessons”

Beginning with initial repetition intervals that contain increasing intervals over time, embodiments of the system and method present a token to a student at the frequency dictated by the repetition intervals. The token is a stimulus-response pair. The student's response to the token is a binary response, either a correct response or an incorrect response. Because the response is binary, embodiments of the system and method are quite lightweight and do not burden the student with determining “degrees” of correctness.

In the non-adaptive embodiments, the system and method determine when next to present the token to the student based on the student's response to the token. If the response is correct, then the token is presented to the student based on the initial repetition interval without modification. If the response is incorrect, then the learnedness value is reset and the progression through the repetition intervals is restarted. The repetition intervals, however, do take into account that the student has previously seen the material such that the progression through the repetition intervals is expanded as the student continues to provide correct responses to the token.

In the adaptive embodiments, the system and method dynamically adjust the initial repetition intervals based on the student's response to revise the repetition intervals. If the response is correct, then the initial repetition intervals may be increased based on a desired learning goal of the student. This decreases the frequency at which the token (and thus the learning material) is presented to the student. In this case it may be that the student is a quick learner. If the response is incorrect, then the initial repetition intervals may be decreased based on the desired learning goal. This serves to increase the frequency at which the token is presented to the student. This case may occur when the student is learning more slowly than the initial repetition intervals represent.

In these adaptive embodiments the system and method are able to adapt to the student's learning curve. Embodiments of the system and method take into account that different people learn at different rates, and can adapt to a particular student's learning curve. This is achieved by manipulating the exponent of the mathematical term that represents the curve of the repetition intervals according to the student's pattern of correct or incorrect responses. For example, the Pimsleur intervals have an exponent such that the repetition intervals are 5 seconds, 25 seconds, and so forth. These Pimsleur intervals follow that curve no matter whether the student is actually giving correct responses and reaching a learning goal. Embodiments of the system and method do not stay on the original repetition intervals curve, but are dynamically changing based on the pattern of the student's responses.

Embodiments of the system and method can be used for language learning, or in any situation where a person wants to remember something for a short-term deadline. This may include when a person has to give a talk or prepare to have a conversation in a foreign language. Embodiments of the system and method also may be used in any situation where the person wants to remember something seen in the world, such as recording an audio clip of someone that the person spoke with, so as to remember that person's name. Embodiments of the system and method can also be used with visual items, so that a person can take photographs of things he wants to remember, or items from a book.

Some embodiments of the system and method include a feedback feature that allows the student to provide feedback to the system for some given learning material. Namely, the student provides feedback about how long they have remembered an item of the learning material. Based on this feedback, a learnedness value can be generated that takes into account this fact. Some embodiments of the system and method also include a modeling feature that allows a learnedness value to be computed and associated with a given learning item based on the large-scale data collected over a plurality of students.

Some embodiments of the system and method allow a student to prepare for a particular future date by telling the student how much time is needed to accomplish this goal. Some embodiments of the system and method use a large-scale statistics database to collect and store statistics. These statistics allow embodiments of the system and method to determine how difficult items are to learn relative to other items, rather than just relative to a particular student. Moreover, the learnedness value can be adjusted based on this data such that the learnedness value changes not only relative to a particular student's learning style but also to the large-scale statistics of a particular item to be learned.

Some embodiments of the system and method also include a scheduling feature that takes into account the scheduling and calendaring information available on the student's digital devices to schedule time to learn. Moreover, embodiments of the system and method can use human activity inference to detect various state of the student, such as sitting, standing, walking, running, cycling, travelling in a vehicle, and so forth. This state information can be used to identify opportune moments to study, based on expressed preferences or historic use patterns of the student. Embodiments of the system and method can schedule time for the student to learn by taking into account external factors for scheduling learning sessions. Moreover, embodiments of the system and method can examine overdue items and schedule the student to learn these items when the student has free time. Some embodiments of the system and method also include a performance weighting feature that identifies the best hours of the day for the student to learn and schedule learning tasks accordingly.

It should be noted that alternative embodiments are possible, and steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of an adaptively-spaced repetition learning system and method implemented in a computing environment.

FIG. 2 is a flow diagram illustrating the general operation of the non-adaptive learning embodiments of the adaptively-spaced repetition learning system shown in FIG. 1.

FIG. 3 is a flow diagram illustrating the general operation of the adaptive learning embodiments of the adaptively-spaced repetition learning system shown in FIG. 1.

FIG. 4 is a flow diagram illustrating the operational details of embodiments of the learning module shown in FIG. 1.

FIG. 5 is a flow diagram illustrating the operational details of embodiments of the adaptivity module shown in FIG. 1.

FIG. 6 is a flow diagram illustrating the operational details of embodiments of the feedback module shown in FIG. 1.

FIG. 7 is a flow diagram illustrating the operational details of embodiments of the modeling module 140 shown in FIG. 1.

FIG. 8 illustrates a simplified example of a general-purpose computer system on which various embodiments and elements of the adaptively-spaced repetition learning system and method, as described herein and shown in FIGS. 1-7, may be implemented.

### DETAILED DESCRIPTION

In the following description of embodiments of an adaptively-spaced repetition learning system and method reference is made to the accompanying drawings, which form a part thereof, and in which is shown by way of illustration a specific example whereby embodiments of the adaptively-spaced repetition learning system and method may be practiced. It is to be understood that other embodiments may be utilized and structural changes may be made without departing from the scope of the claimed subject matter.

### I. System Overview

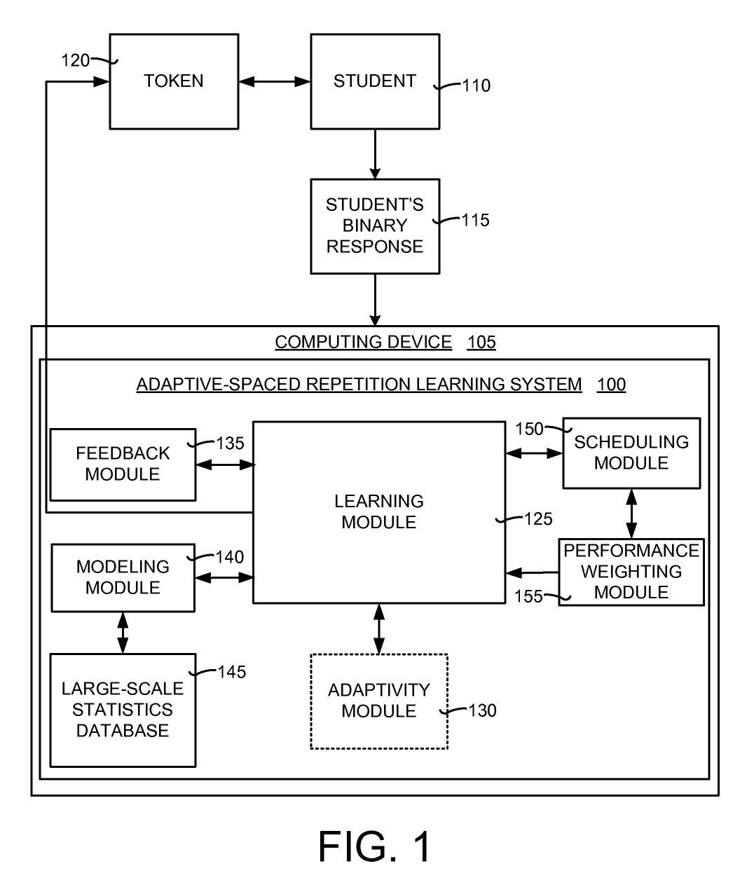

FIG. 1 is a block diagram illustrating a general overview of embodiments of an adaptively-spaced repetition learning system and method implemented in a computing environment. As shown in FIG. 1, embodiments of the adaptively-spaced repetition learning system 100 and method are implemented on a computing device 105. Embodiments of an adaptively-spaced repetition learning system 100 and method input from a student 110 the student's binary response 115. The student's binary response 115 is either a correct answer or an incorrect answer, which is in response to a token 120 displayed to the student 110 by embodiments of the system 100 and method. A token 120 is a stimulus-response pair, where the student 110 is shown a stimulus and provides a response to the stimulus.

Embodiments of the adaptively-spaced repetition learning system 100 and method include a learning module 125 that contains the core learning technique. This core learning technique is a non-adaptive technique that keeps the same interval spacing. An optional (as shown by the dotted line) adaptivity module 130 can be used by the learning module 125 to add adaptivity to the learning technique. This adaptive learning technique changes interval spacing based on the student's learning style.

Embodiments of the adaptively-spaced repetition learning system 100 and method include a number of enhancements to the learning module 125. In particular, embodiments of the system 100 and method include a feedback module 135, a modeling module 140, and a large-scale statistics database in communication with the modeling module 140. The feedback module 135 helps estimate an initial learnedness value, while the module 140 can maintain a word model per item, which describe how difficult the item is to learn. This can be based on the learning experience of other students, and can be stored in the large-scale statistics database 145.

Embodiments of the system 100 and method also include a scheduling module 150 and performance weighting module 155. The scheduling module 150 takes into account a student's schedule and facilities maximizing learning time and reaching learning goals. The performance module 155 uses the student's past performance to select the best times for learning to occur.

### II. Operational Overview

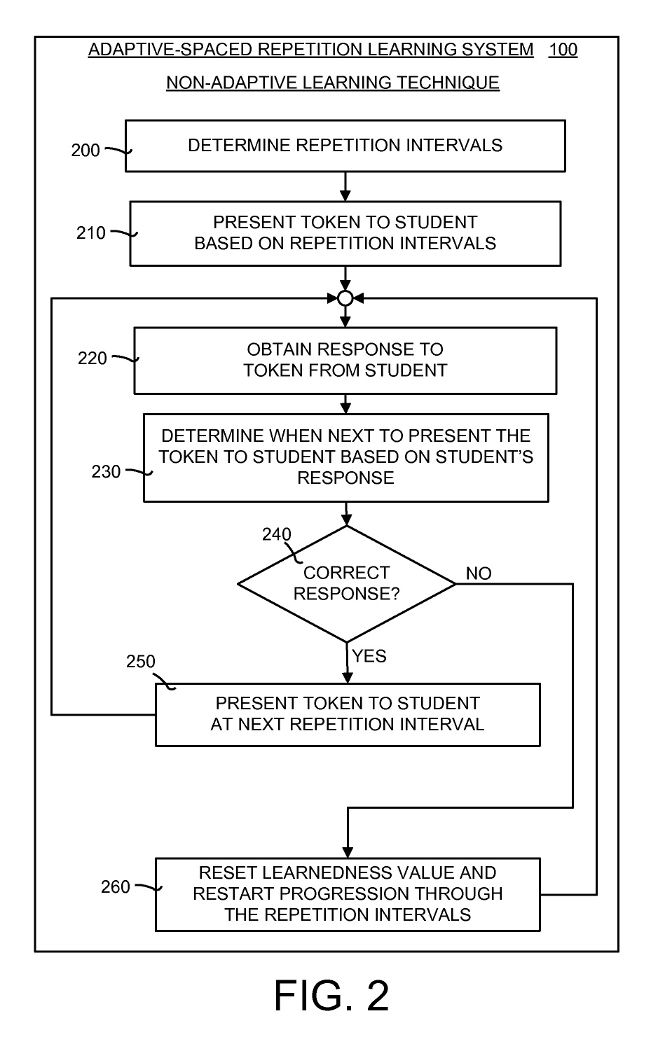

FIG. 2 is a flow diagram illustrating the general operation of the non-adaptive learning embodiments of the adaptively-spaced repetition learning system 100 shown in FIG. 1. In general, the non-adaptive learning embodiments of the adaptively-spaced repetition learning system 100 and method facilitate efficient and effective learning by using non-adaptive repetition intervals and feedback based on student responses. This non-adaptive technique provides a token to the student at regularly-spaced repetition intervals as long as the student continues to provide correct responses. Once an incorrect response is given, the learnedness value is reset and the progression through the repetition intervals is restarted. The repetition intervals, however, do take into account that the student has previously seen the material such that the progression through the repetition intervals is expanded as the student continues to provide correct responses to the token. In other words, if the student has correctly answered previously this helps the student to progress faster through the repetition intervals.

As shown in FIG. 2, the method begins by determining the repetition intervals (box 200). Next, a token is presented to the student at the frequency based on the repetition intervals (box 210). A response to the token then is obtained from the student (box 220).

The method determines when next to present the token to the student based on the student's response (box 230). In particular, a determination is made as to whether a correct response was provided by the student to the token (box 240). In some embodiments this is self-reported by the student, while in other embodiments it is determined through analysis of student-contributed speech or text responses. If the response is correct, then the method presents the token to the student at the next repetition interval (box 250). If the response is incorrect, then the learnedness value is reset and the progression through the repetition intervals is restarted (box 260). The repetition intervals, however, do take into account that the student has previously seen the material such that the progression through the repetition intervals is expanded as the student continues to provide correct responses to the token.

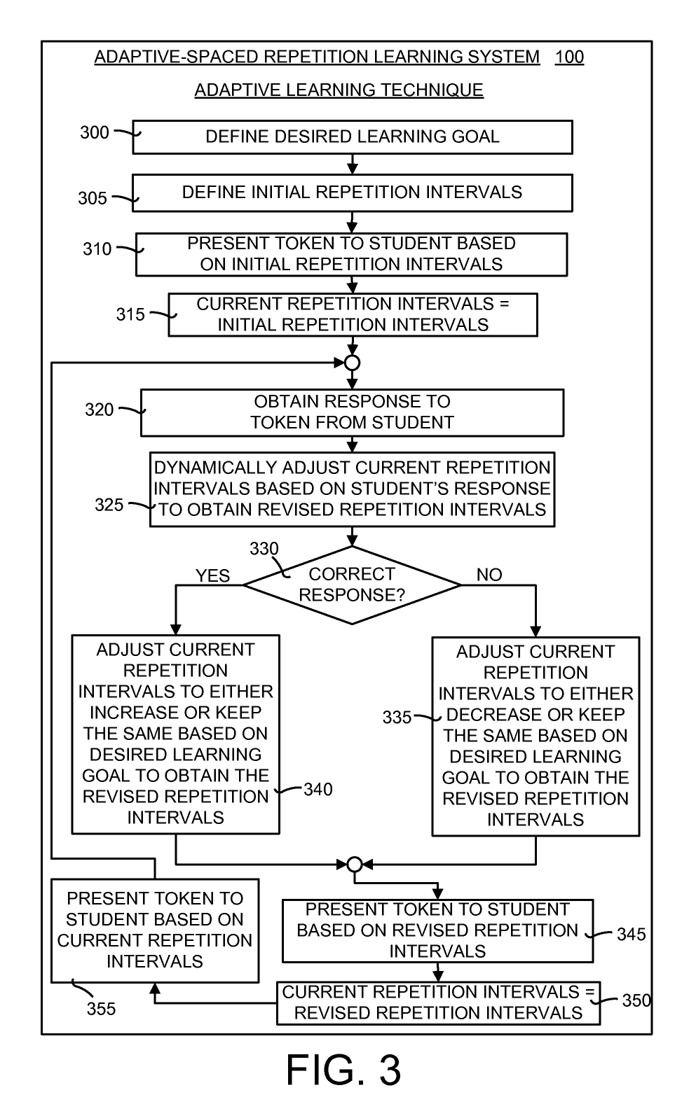

FIG. 3 is a flow diagram illustrating the general operation of the adaptive learning embodiments of the adaptively-spaced repetition learning system 100 shown in FIG. 1. In general, the adaptive learning embodiments of the adaptively-spaced repetition learning system 100 and method facilitate efficient and effective learning by adapting to a particular student's learning curve. The adaptive technique changes the spacing of the intervals based on the student's responses. This is effectively adapting the interval curve to the individual student's learning curve.

Referring to FIG. 3, the operation of the adaptive learning embodiments of the adaptively-spaced repetition learning system 100 and method begin by defining a desired learning goal (box 300) and the initial repetition intervals (box 305). Next, the method present the token to the student based on the frequency set forth by the initial repetition intervals (box 310). The initial repetition intervals are then called current repetition intervals (box 315).

A response to the token then is obtained from the student (box 320). The method then dynamically adjusts the current repetition intervals based on the student's response (box 325). This dynamic adjustment yields revised repetition intervals.

Specifically, embodiments of the method then make a determination as to whether the student's response is correct (box 330). If not, then the method adjusts the current repetition intervals to either decrease or stay the same based on the desired learning goal in order to obtain the revised repetition intervals (box 335). If the response is correct, then the embodiments of the method adjust the current repetition intervals to either increase or stay the same based on the desired learning goal to obtain the revised repetition intervals (box 340).

From then on the token is presented to the student based on the frequency set forth in the revised repetition intervals (box 345). The current repetition intervals then are set equal to the revised repetition intervals (box 350). The process then begins again with the method presenting the token to the student based on the current repetition intervals (box 355).

### III. Operational Details

The operational details of embodiments of the adaptively-spaced repetition learning system 100 and method will now be discussed. This includes the operation of the learning module 125, the adaptivity module 130, the feedback module 135, and the modeling module 140. In addition, the mathematical details of the operation of embodiments of the adaptively-spaced repetition learning system 100 and method will be discussed.

### III.A. Learning Module

Embodiments of the adaptively-spaced repetition learning system 100 and method described herein include a learning module 125. Embodiments of the learning module 125 contain repetition intervals that are spaced based on a student's responses. The intervals in some embodiments of the learning module 125 are 5 to the power of “learnedness,” (5^{l}), where learnedness (l) gets larger each time the student gives a correct response. It should be noted that other exponent based may be used in other embodiments. However, it should be noted that x^{y} can by always be expressed as 5^{z}, where z is calculated from x and y. If the student gives an incorrect response then the student is sent back to the beginning of the curve and the learnedness value is reset. Note that in some embodiments of the learning module 125 the intervals do not change over time based on the pattern of the student's responses.

### III.A.1. Core Learning Technique

Embodiments of the learning module 125 include a core learning technique that is based on a learnedness value stored for every token. In general, a token is a stimulus-response pair where a student is presented with a stimulus (such as an English word), and the student provides a response (such as the Chinese translation of the English word).

The learnedness value is an estimate of the strength of the association of the stimulus-response pair at the time immediately following the learner's last response. The learnedness value is adjusted based on each response, depending on whether it was a positive or negative response.

For each token, embodiments of the core learning technique also store two values that affect how the learnedness value changes over time. The first value stored is a rate of increase. The rate of increase is used to increment the learnedness value after a positive response. The second value stored is the reset rate of increase, which replaces the rate of increase when there is a negative response. Both of these values are described in more detail below.

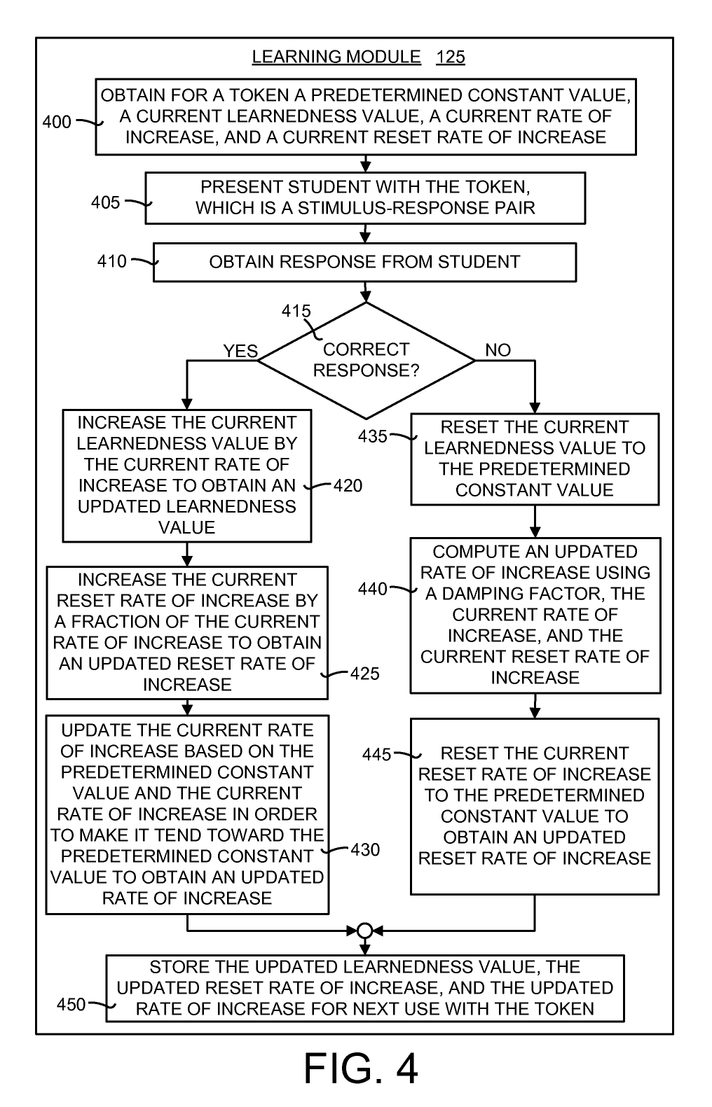

FIG. 4 is a flow diagram illustrating the operational details of embodiments of the learning module 125 shown in FIG. 1. The operation of the module 125 begins by obtaining a token, a predetermined constant value, a current learnedness value, a current rate of increase, and a current reset rate of increase (box 400). The module 125 then presents the student with the token (box 405), and obtain a response from the student (box 410). A determination then is made as to whether the student's response is correct (box 415).

### III.A.2. Positive Responses

In general, if the student's response is correct, and the student keeps answering correctly, then embodiments of the learning module 125 make sure that if the student ever gets it wrong that the student will not have to follow the standard high-frequency repetitions to get back to where the student was. This is where the notion of the “reset rate of increase” comes in. Essentially, if the student can keep answering correctly, the more history the student has of answering correctly, then the faster the student can “catch up” if he ever gets it wrong.

Specifically, if the student's response is correct, and the student provides a positive response for a token, embodiments of the learning module 125 respond as follows. First, the current learnedness value is increased by the current rate of increase to obtain an updated learnedness value (box 420). Second, the current reset rate of increase, rᵣₑₛₑₜ, is increased by a fraction of the current rate of increase to obtain an updated reset rate of increase (box 425). In some embodiments, this fraction is equal to one-quarter of the current rate of increase.

The purpose of this is that if a student has previously recalled a token correctly numerous times and then makes one error, this does not necessarily imply that the student has completely forgotten the token. As a result, the negative response will still reset the learnedness value for the phrase. However, if the student correctly recalls the token in subsequent attempts, then the learnedness value will increase more quickly than normal.

Third, the current rate of increase is adjusted or updated based on the predetermined constant value and the current rate of increase in order to make it tend toward the predetermined constant value and obtain an updated rate of increase (box 430). More specifically, in order to make the rate of increase tend toward the predetermined constant value (c₀), such that c₀=0.1, the following equation is used:

r_{new}=c₁(r_{old}−c₀)+c₀

Here, r_{old} is the current (or old) rate of increase, and r_{new} is the new (or updated) rate of increase. In some embodiments, the first constant c₁=0.25.

### III.A.3. Negative Responses

In general, an incorrect response by the student sends the student back to the beginning. In this case the learnedness value is reset, meaning that the student needs to relearn the material. There is a difference between if the student has known it quite well in the past and if you are learning something new for the first time. More specifically, when the student provides a negative response for a token, embodiments of the learning module 125 respond as follows. First, the current learnedness value is reset to the predetermined constant value, c₀.

Second, the current reset rate is updated using a damping factor (c₂), the current rate of increase, and the current reset rate of increase to obtain an updated rate of increase (box 440). Mathematically, the updated rate of increase is obtained using the equation:

$${r}_{new} = {c}_{2} {r}_{reset} \frac{{r}_{old}}{{c}_{0}} .$$

The damping factor, c₂, acts such that repeatedly giving an incorrect response to a token causes it to appear more frequently than other tokens, as it is more difficult to the particular learner. In some embodiments, the damping factor, c₂, is set to 0.8. Both the reset rate of increase and previous rate of increase are used to set a new rate of increase.

Third, the current reset rate of increase is reset to the value of the predetermined constant value, c₀ (box 334). This yields an updated reset rate of increase. The updated learnedness value, the updated reset rate of increase, and the updated rate of increase, are stored for the next use with the token (box 450).

### III.A.4. Interarrival Time

An interarrival time, t₁, can be calculated as follows based on the learnedness value, l:

$${t}_{I} = {5}^{10 l} = {e}^{\frac{10 l}{{log}_{5} e}} .$$

These interarrival times are given as “5 seconds, 25 seconds, 2 minutes, 10 minutes, 1 hour, 5 hours, 1 day, 5 days, 25 days, 4 months, 2 years”, and closely follows a curve of 5^{x}, where x is the repetition number. Since l roughly increases in increments of 0.1 (which in some embodiments, is the value of c₀), the above equation approximates these increments. Note that these are the interarrival times given by the Pimsleur approach, and that the curve of the repetition intervals is derived from these interarrival times.

Token selection is based on the interarrival times of tokens. Mathematically, let tₚ be the time elapsed since the last response for a token p. When a new token is required, all tokens where tₚ≧t₁ are considered. From these tokens, embodiments of the adaptively-spaced repetition learning system and method select the token with the highest ratio of tₚ/t₁, which is the token considered the most overdue.

This ensures that those tokens with low learnedness values that are a few seconds late are given higher priority than tokens with high learnedness values that are also a few seconds late. If there are no such tokens to select from, a new, previously unseen token is requested.

### III.B. Adaptivity Module

Many learning systems assume that student learns at the same rate. In the Pimsleur system, this is addressed by suggesting that lessons are repeated until an 80% comprehension rate is achieved. However the same repetition intervals are still used for all students. As a result, fast learners may get bored by having to recall tokens too frequently, while slow learners may lose motivation by getting tokens wrong too often.

Embodiments of the adaptively-spaced repetition learning system 100 and method include an adaptivity module 130 that adds adaptivity to the learning module 125 in an attempt to infer the learning curve of the student. Embodiments of adaptivity module 130 cause the repetition intervals to diverge away from the Pimsleur intervals, thereby modeling the learning curve of a particular student. Thus, if someone learns faster than another, embodiments of the system 100 and method it can adapt.

For example, suppose there are some students that have a learning style whereby they do not learn the material quickly early on, but once they get it they just do not forget the material. For these people, embodiments of the system 100 and method provides a great deal of repetition early on, but once they reach a certain point, embodiments of the system 100 and method can learn that they only need to be tested at longer intervals between. As another example, another student may have a learning style whereby they hear something and do some mental trick to create some metaphor so that they will do fine being tested less frequently. If this is a consistent pattern of behavior, then embodiments of the system 100 and method can adapt accordingly. This adaptation by embodiments of the system 100 and method allows the student to make the best use of his time.

In order to achieve this adaptation, embodiments of the adaptivity module 130 record the expected number of correct responses, the actual number of correct responses, and the total number of responses across all tokens for a particular student. Embodiments of the module 130 break the responses down based on the learnedness value of the token at the time of the previous response. These then are grouped together into buckets of size 0.1. For example, all responses for tokens that had learnedness values between 0.3 and 0.4 at the time of the previous response are grouped into a single bucket. Note that embodiments of the adaptivity module group them based on the previous learnedness value rather than the current value. This is because it is the amount of the adjustment from the previous learnedness value that determines the likelihood of a correct response at the current level.

Embodiments of the adaptivity module 130 then record the statistics above for each bucket, in addition to global statistics. While two of the above statistics are self-explanatory, the expected number of correct responses requires some description, and are described in detail below.

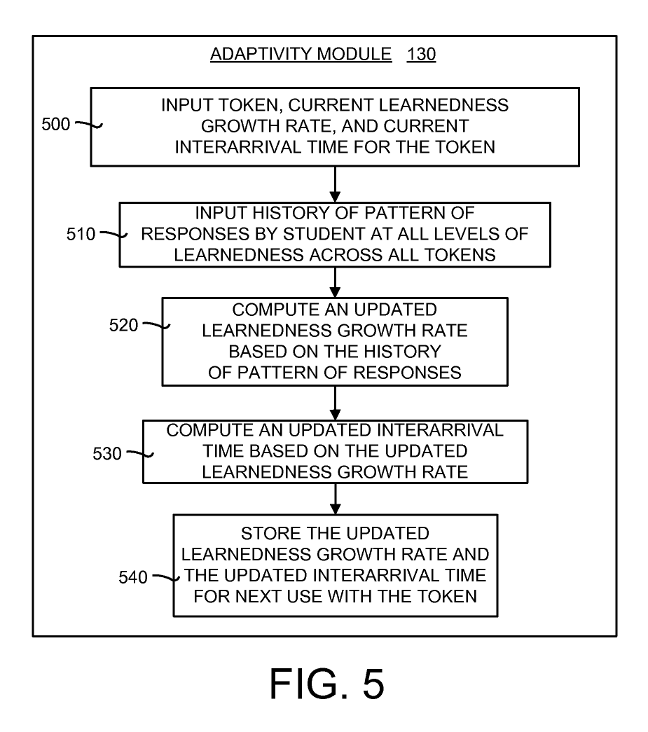

FIG. 5 is a flow diagram illustrating the operational details of embodiments of the adaptivity module 130 shown in FIG. 1. The operation of the module 130 begins by inputting a token, a current learnedness growth rate, and a current interarrival time for the token (box 500). Next, the module 130 inputs a history of patterns of responses by the student at all levels of learnedness and across all tokens (box 510).

In particular, the adaptivity module 130 examines the student's proportion of correct responses at all levels of learnedness across all tokens, and not just the token under consideration. In this manner, the module 130 is able to adapt to the student's memory. The module 130 updates the rate at which learnedness grows for a particular token based on future correct responses.

The module 130 then computes an updated learnedness growth rate based on the history of the pattern of responses by the student (box 520). Moreover, an updated interarrival time is computed based on the updated learnedness growth value (box 530). The module 130 then stores the updated learnedness growth value and the updated interarrival time for the next use with the token (box 540).

In general, embodiments of the module 130 change the interarrival times based on a history of the student's responses. This is done by manipulating the learnedness value in increments that are not just 0.1 (as in the Pimsleur intervals), but that are bigger or smaller, based on the pattern of responses. In this manner, embodiments of the module 130 move away from the Pimsleur intervals and create repetitions intervals customized for a particular student.

In mathematical terms, the human forgetting curve can be described as follows:

$$R = {e}^{- \frac{t}{S}} .$$

Here, R is memory retention, t is time and S is the relative strength of memory. Embodiments of the module 130 consider the inter-arrival time t₁ to be the strength of memory and use it to replace S, while t is replaced with the time since the previous response.

Embodiments of the module 130 refer to memory retention as E(recall). In other words, E is the expected number of correct responses. Additionally, embodiments of the module 130 apply a scale factor inside the exponent of ln(0.9) to give a target accuracy of 90%, which is in line with other systems (such as the Pimsleur system).

Mathematically, the equation then becomes:

$$E ( recall ) = {e}^{- ln ( 0.9 ) \frac{t}{{t}_{I}}} = {0.9}^{\frac{t}{{t}_{I}}} .$$

For example, if the response is exactly when it was scheduled by embodiments of the system and method, then E(recall) will be 90%. For learners who have different learning rates than the assumed rate, the interarrival time t₁ must be artificially adjusted.

For example, for a slower learner who has attained smaller than 90% recognition, decreasing t₁ would increase the recognition rate. The actual time would also decrease accordingly, so E(recall) would stay approximately the same. In effect, the interarrival time is being adjusted so that the actual number of correct responses approaches the expected number of correct responses.

In embodiments of the adaptivity module 130, E is calculated as follows, with T being the total number of recalls:

E=0.9T.

This assumes that all tokens are reviewed exactly when their interarrival times dictate (in other words, t=t₁), and that embodiments of the system and method are only calculating a new ideal interarrival time rather than an actual one. A function F(t₁) can be used that converts an ideal interarrival time into an actual interarrival time. A fair assumption can be made that the same function applies to the new value of t₁.

Rearranging the equation above yields:

$$\frac{t}{{t}_{I}} = {log}_{0.9} ( 0.9 \frac{A}{E} ) = 1 + {log}_{0.9} ( \frac{A}{E} ) .$$

For this equation, t is the actual time that has elapsed historically, which has resulted in the value of A that has been observed. Using the same logic as for the calculation of E, t is set to a current estimation of t₁, or in other words it is assumed that the repetitions all occurred at the optimal times. Moreover, t_{1(new)} is used in place of t₁, since t_{t1(new)} represents a theoretically ideal value which has existed all along, but has been misestimated as t₁. This results in the following equation:

$$\frac{{t}_{I ( new )}}{{t}_{I}} = \frac{1}{1 + {log}_{0.9} ( \frac{A}{E} )} .$$

To simplify the working below, the following values are defined:

$$h = {log}_{0.9} ( \frac{A}{E} )$$

$$k = \frac{10}{{log}_{5} e} .$$

Also, recall the equation for t₁ described previously:

$${t}_{I } = {e}^{\frac{10 l}{{log}_{5} e}} = {e}^{kl} .$$

Now, substituting this equation into the one above, a new learnedness value can be calculated as:

$$\frac{{e}^{{kl}_{new}}}{{e}^{kl}} = \frac{1}{1 + h}$$

$$\begin{matrix}∴ {l}_{new} = \frac{ln \frac{{e}^{kl}}{1 + h}}{k} \\ = \frac{ln ( {e}^{kl} ) - ln ( 1 + h )}{k} \\ = \frac{kl - ln ( 1 + h )}{k} \\ = l - \frac{ln ( 1 + h )}{k} \\ = l - \frac{ln ( 1 + {log}_{0.9} ( \frac{A}{E} ) ) {log}_{5} e}{10} .\end{matrix}$$

Using the value of E calculated above, this can be simplified slightly as follows:

$$\begin{matrix}{l}_{new} = l - \frac{ln ( 1 + {log}_{0.9} ( \frac{A}{0.9 T} ) ) {log}_{5} e}{10} \\ = l - \frac{ln ( {log}_{0.9} ( \frac{A}{T} ) ) {log}_{5} e}{10} .\end{matrix}$$

Embodiments of the module 130 store base increase rates for each bucket as well as a global increase rate. Initially, these are each set to c₀. After each response given by the student, they are updated based on the equation above to:

$$r = {c}_{0} - \frac{ln ( {log}_{0.9} ( \frac{A}{T} ) ) {log}_{5} e}{10} .$$

For a bucket, only those responses that apply to the bucket are used in the calculation, while for the global statistics all responses for positive learnedness values are used. This excludes tokens with learnedness values of zero (or those which have not been previously encountered), since they would significantly bias the statistics.

In reality, r is restricted to a certain range to ensure that it is not over adjusted in the case of unusual student history. For example, if the student has obtained 5 tokens correct in a given bucket, it would not make sense to assume that they will get all future tokens correct. The ratio A/T is just an estimate of the probability of a correct response, which will become more accurate as T increases. The level of restrictions on r therefore depend on the value of T. The smaller T is, then the tighter the restrictions.

The bounds used by embodiments of the module 130 are as follows. Note that c₃=10 and c₄=0.20:

$${r}_{min} = \frac{{c}_{0} {c}_{3}}{T + {c}_{3} - 1}$$

$${r}_{max} = {c}_{4} - \frac{( {c}_{4} - {c}_{0} ) {c}_{3}}{T + {c}_{3} - 1} .$$

When T=1, these limits ensure that r=c₀, however as T increases, more flexibility is given. Embodiments of the system and method have the following limits:

$${lim}_{T \to ∞} [ {r}_{min} , {r}_{max} ] = [ 0 , {c}_{4} ] .$$

When a response is correct, some embodiments of the adaptively-spaced repetition learning system and method then select a base rate of increase (before applying any applicable scale factors) as follows. First, if there have been at least five responses in the same bucket as the current response, this means the token has been encountered before. In this case the bucket's base rate of increase is used. Otherwise, global rate of increase is used. This ensures that embodiments of the system and method do not start adapting to a given student's learning curve before there is enough data to make such adjustments.

Note that in the equation for l_{new}, embodiments of the module 130 deduct a value for l. On the other hand, for the bucket increase rates embodiments of the module 130 deduct it from c₀. Since the bucket increase rate is used to increment l in the case of a correct response, these have the same effect, except that some embodiments of the module 130 do not modify learnedness values for existing tokens. These embodiments of the module 130, however, will still converge on the student's actual learning curve given sufficient user history.

### III.C. Feedback Module

Some embodiments of the system 100 and method assume that the student is an absolute beginner and has no prior experience with the material to be learned. The feedback module 135 can be used to add the feature to allow the student to provide feedback to the system for given learning material. For example, the student could provide feedback about how long he has remembered a given vocabulary word in a foreign language. Based on this feedback, a learnedness value can be generated that takes into account this fact.

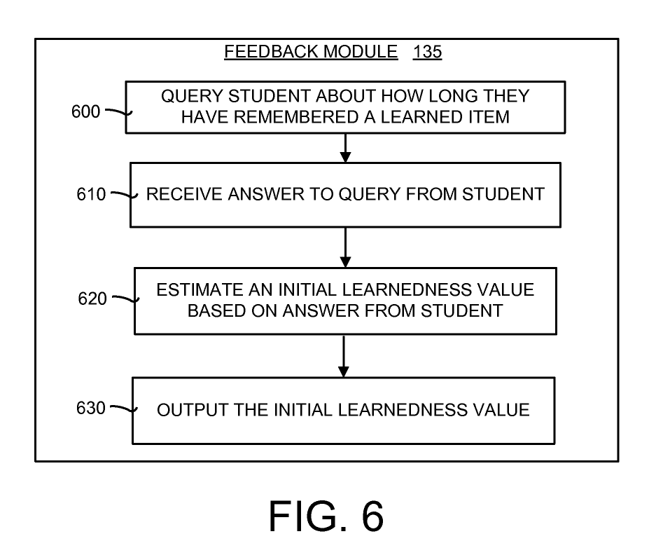

FIG. 6 is a flow diagram illustrating the operational details of embodiments of the feedback module 135 shown in FIG. 1. Operation of the module 135 begins by querying the student about how long they have remembered a learned item (box 600). Next, the module 135 receives an answer to the query from the student (box 610). The module 135 then estimates an initial learnedness value based on the answer provided by the student (box 620). This initial learnedness value then is output for association with the learned item (box 630).

### III.D. Modeling Module

Some embodiments of the system 100 and method make a homogenous complexity assumption, which means that it assumes that all learning material has an equal level of difficulty to learn. However, this is not true in the real world. For example, when learning a foreign language, some words are harder to learn than others. Also, phrases of words do not all have the same degree of difficulty. Embodiments of the modeling module 140 allow a learnedness value to be computed and associated with a given learning item based on the large-scale data collected over a plurality of students.

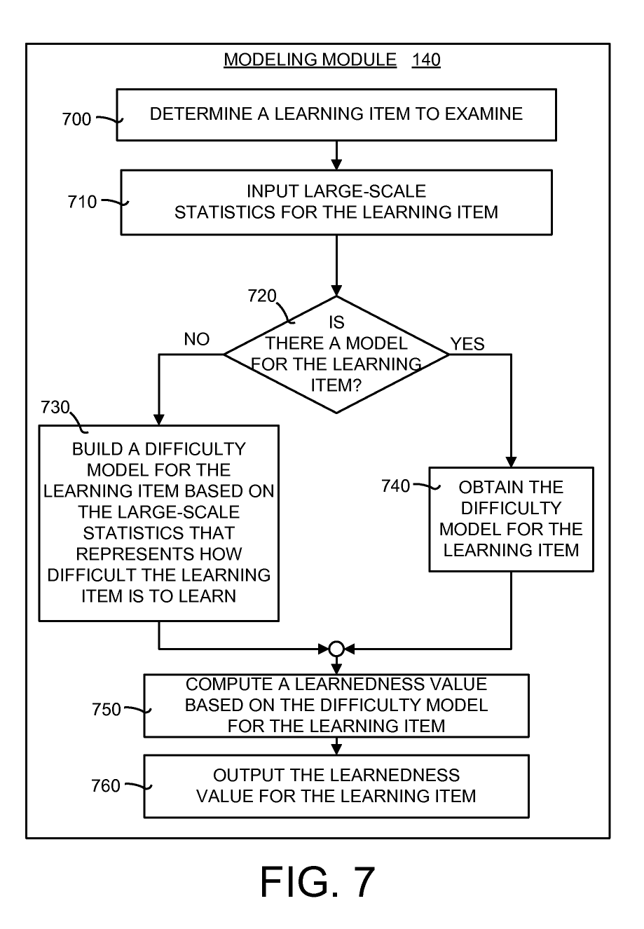

FIG. 7 is a flow diagram illustrating the operational details of embodiments of the modeling module 140 shown in FIG. 1. The operation of embodiments of the modeling module 140 begin by determining a learning item to examine (box 700) and inputting large-scale statistics for the learning item (box 710). Typically, these large-scale statistics will be collected and stored in the large-scale statistics database 145.

A determination then is made as to whether there is a model that already exists for the learning item (box 720). If not, then the module 140 builds a difficulty model for the learning item based on the large-scale statistics (box 730). This difficulty model represents how difficult the learning item is to learn, or how much trouble other students as a whole had learning the item. If a model does exist, then the module 140 obtains this difficulty model for the learning item (box 740). For example, the difficulty model could model the difficulties of learning a word in a second language from a native language. In other words, the difficulty is not a property of the word but both of the word and the native language of the student.

The module then computes for the learning item a learnedness value based on the difficulty model (box 750). In other words, using the difficulty model, the module 140 computes a learnedness value that represents the difficulty that others had learning the learning item. The module then outputs this computed learnedness value (box 760).

### III.E. Additional Embodiments

Additional embodiments of the adaptively-spaced repetition learning system 100 and method are possible and will now be described briefly. One embodiment of the adaptively-spaced repetition learning system 100 and method allows the student to prepare for a particular future date. For example, the student may want to use the words of a foreign language he is learning in a conversation at some future date. These embodiments of the adaptively-spaced repetition learning system 100 and method can tell the student how much time is needed to accomplish this goal. If the student decides he does not have enough time to reach this goal, then he can select different words to learn that fit into the time he has available and will still allow him to learn those words to use in a conversation at that future date.

Some embodiments of the adaptively-spaced repetition learning system 100 and method use the large-scale statistics database 145 to collect and store statistics. This means that statistics can be extracted on a large scale and embodiments of the system 100 and method can determine how difficult items are to learn relative to other items, rather than just relative to a particular student. Moreover, as described above, the learnedness value can be adjusted based on this data. Thus, the learnedness value can be changed not only relative to a particular student's learning style but also to the large-scale statistics of a particular item to be learned.

This means that if a student is new to the system 100, embodiments of the system 100 and method will understand how difficult an item is to learn. Rather than rely on the student getting the item to be learned wrong a certain number of times before the system 100 and method recognizes that the item is hard for a particular student, embodiments of the system 100 and method will already know that it is hard to everyone and guess that everyone will have more difficulty with this particular item. With this knowledge, embodiments of the system 100 and method can change the learnedness value to space it more frequently for the user, without you having continually get it incorrect.

Embodiments of the adaptively-spaced repetition learning system 100 and method also include a scheduling module 150 that takes into account the student's digital lifestyle. In these embodiments, the system 100 and method take into account the scheduling and calendaring information available on the student's digital devices to schedule time to learn. For example, assume that the system 100 and method knows that the student will finish a meeting soon and will have an hour free. The system 100 and method can take schedule time for the student to learn by taking into account external factors for scheduling learning sessions.

Moreover, in these embodiments the system 100 and method can look at overdue items and find when the student has free time and schedule these items to learn. Also, based on a particular student's use of the system 100 and method, it can project forward to tell the student the milestone that will be reached over time based on the current pace of learning. This makes the student's learning much more tangible. In this manner, the scheduling module 150 uses information provided by the embodiments of the system 100 and method to not only schedule future repetitions for the student, but also to communicate to the student how their learning efforts are shifting knowledge from short-term memory to long-term memory.

Embodiments of the adaptively-spaced repetition learning system 100 and method also include a performance weighting module 155. In these embodiments, the module 155 adds a weighted performance to the student's schedule. For example, if the module 150 notes that after lunch time the student's performance decreases, then it can recognize that perhaps this is not the time to schedule a difficult item to learn. So the module 155 identifies the best hours of the day to learn and act accordingly. In effect, these embodiments weight different times of the day for learning based on past performance.

### IV. Exemplary Operating Environment

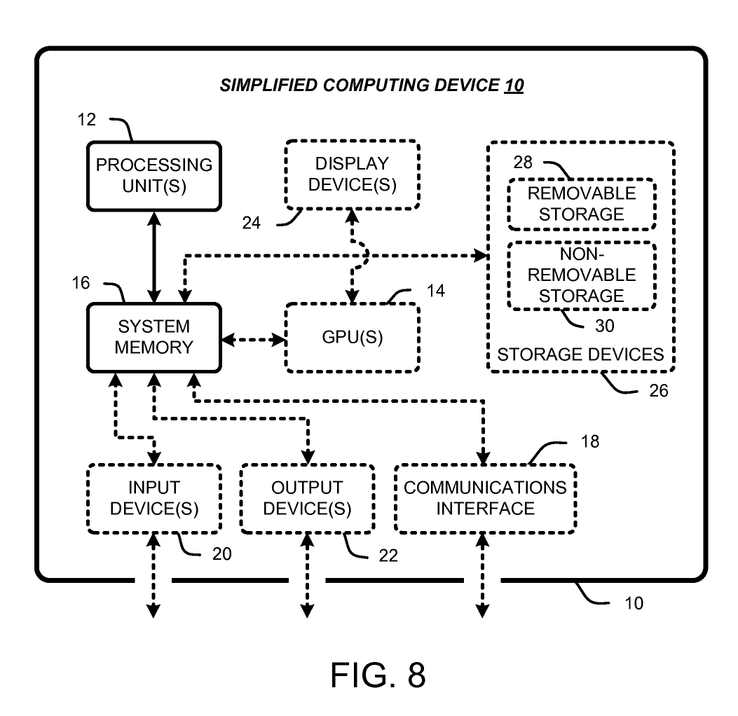

Embodiments of the adaptively-spaced repetition learning system 100 and method described herein are operational within numerous types of general purpose or special purpose computing system environments or configurations. FIG. 8 illustrates a simplified example of a general-purpose computer system on which various embodiments and elements of the adaptively-spaced repetition learning system and method, as described herein and shown in FIGS. 1-7, may be implemented. It should be noted that any boxes that are represented by broken or dashed lines in FIG. 8 represent alternate embodiments of the simplified computing device, and that any or all of these alternate embodiments, as described below, may be used in combination with other alternate embodiments that are described throughout this document.

For example, FIG. 8 shows a general system diagram showing a simplified computing device 10. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement embodiments of the adaptively-spaced repetition learning system 100 and method described herein, the device should have a sufficient computational capability and system memory to enable basic computational operations. In particular, as illustrated by FIG. 8, the computational capability is generally illustrated by one or more processing unit(s) 12, and may also include one or more GPUs 14, either or both in communication with system memory 16. Note that the processing unit(s) 12 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 8 may also include other components, such as, for example, a communications interface 18. The simplified computing device of FIG. 8 may also include one or more conventional computer input devices 20 (e.g., pointing devices, keyboards, audio input devices, video input devices, haptic input devices, devices for receiving wired or wireless data transmissions, etc.). The simplified computing device of FIG. 8 may also include other optional components, such as, for example, one or more conventional computer output devices 22 (e.g., display device(s) 24, audio output devices, video output devices, devices for transmitting wired or wireless data transmissions, etc.). Note that typical communications interfaces 18, input devices 20, output devices 22, and storage devices 26 for general-purpose computers are well known to those skilled in the art, and will not be described in detail herein.

The simplified computing device of FIG. 8 may also include a variety of computer readable media. Computer readable media can be any available media that can be accessed by computer 10 via storage devices 26 and includes both volatile and nonvolatile media that is either removable 28 and/or non-removable 30, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Retention of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the adaptively-spaced repetition learning system 100 and method described herein, or portions thereof, may be stored, received, transmitted, or read from any desired combination of computer or machine readable media or storage devices and communication media in the form of computer executable instructions or other data structures.

Finally, embodiments of the adaptively-spaced repetition learning system 100 and method described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Moreover, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for learning material containing a plurality of learning items, comprising:
determining repetition intervals that represent a frequency with which a learning item is presented to a student;
presenting a token, which is a stimulus-response pair, to the student based on the repetition intervals;
obtaining a response to the token from the student; and
determining when next to present the token to the student based on the student's response.

2. The method of claim 1, further comprising:
determining that an incorrect response to the token was given by the student; and
presenting the token next to the student at a beginning of the repetition intervals.

3. The method of claim 2, further comprising resetting a current learnedness value to a predetermined constant value.

4. The method of claim 3, further comprising computing an updated rate of increase using a damping factor, a current rate of increase, and a current reset rate of increase.

5. The method of claim 4, further comprising:
resetting the current reset rate of increase to the predetermined constant value to obtain an updated reset rate of increase; and
storing the updated learnedness value, the updated rate of increase, and the updated reset rate of increase for next use with the token.

6. The method of claim 1, further comprising:
determining that a correct response to the token was given by the student; and
increasing a current learnedness value by a current rate of increase to obtain an updated learnedness value.

7. The method of claim 6, further comprising increasing a current reset rate of increase by a fraction of the current rate of increase to obtain an updated reset rate of increase.

8. The method of claim 7, further comprising:
updating the current rate of increase based on a predetermined constant value and the current rate of increase in order make the current rate of increase tend towards the predetermined constant value and to obtain an updated rate of increase; and
storing the updated learnedness value, the updated rate of increase, and the updated reset rate of increase for next use with the token.

9. The method of claim 1, further comprising:
obtaining a token, a current learnedness growth rate, and a current interarrival time for the token;
obtaining a history of responses by the student at all levels of learnedness and across all tokens; and
adjusting the current learnedness growth rate based on the history of responses to obtain an updated learnedness growth rate.

10. The method of claim 9, further comprising computing an updated interarrival time based on the updated learnedness growth rate.

11. The method of claim 1, further comprising:
querying the student about how long they have remembered a learning item;
receiving an answer to the query from the student; and
estimating an initial learnedness value based on the answer from the student.

12. The method of claim 1, further comprising:
determining a learning item to examine;
obtaining large-scale statistics for the learning item;
building a difficulty model for the learning item using the large-scale statistics, the difficulty model representing how difficult the learning item is for students to learn; and
computing a learnedness value based on the difficulty model.

13. A computer-implemented method for using adaptive-spaced repetition intervals to learn, comprising:
using the computer to perform the following process actions:
defining initial repetition intervals representing a frequency at which a token is presented to a student;
presenting the token to the student;
obtaining a response to the token from the student; and
dynamically adjusting the initial repetition intervals based on the student's response to obtain revised repletion intervals that accurately model the student's learning curve.

14. The computer-implemented method of claim 13 further comprising obtaining a binary response from the student such that the student's response is either correct or incorrect.

15. The computer-implemented method of claim 14, further comprising:
determining that the student's response is a correct response; and
increasing the initial repetition intervals based on a desired learning goal to obtain revised repetition intervals such that the token is presented to the student less frequently than specified by the initial repletion intervals.

16. The computer-implemented method of claim 15, further comprising:
obtaining a history of student responses at all levels of learnedness and across all tokens;
computing an updated learnedness growth rate based on the history of student responses; and
computing an updated interarrival time based on the updated learnedness growth rate such that the interarrival time is associated with the revised repetition intervals.

17. The computer-implemented method of claim 14, further comprising:
determining that the student's response is an incorrect response; and
decreasing the initial repetition intervals based on a desired learning goal to obtain revised repetition intervals such that the token is presented to the student more frequently than specified by the initial repletion intervals.

18. The computer-implemented method of claim 17, further comprising presenting the token to the student at a beginning of the revised repetition intervals.

19. An adaptively-spaced repetition learning system for allowing a student to learn, comprising:
a computing device comprising a display device and a user interface input device;
a computer program comprising program modules executed by the computing device, comprising,
a token that is a stimulus-response pair that is presented to the student on the display device;
a binary response from the student in response to the token inputted to the system using the user interface input device;
a learning module that determines when next to present the token to the student based on the binary response;
an adaptivity module that dynamically adjusts initial repetition intervals based on the binary response to obtain revised repetition intervals that accurately model the student's learning curve;
a feedback module that determines an initial learnedness value based on the student's answer to a query about how long the student has remembered the learning item contained by the token;
a scheduling module that determines when to present the token based in part by taking into account the student's digital calendar when presenting the token; and
a performance weighting module that determines when to present the token based in part by taking into account the student's past performance during different times of the day.

20. The adaptively-spaced repetition learning system of claim 19, further comprising modeling module that computes the initial learnedness value based on a difficulty model for a particular learning item that is based on large-scale statistics collected for a plurality of students.
